(19) United States
(12) Patent Application Publication
(10) Pub. No.: US 2004/0224754 A1
(43) Pub. Date: Nov. 11, 2004

(54) Gambling apparatus

(76) Inventor: Donald William Bursill, Guernsey (AU)

Correspondence Address: IPSOLON LLP, 805 SW BROADWAY, #2740, PORTLAND, OR, 97205, US

(21) Appl. No.: 10/471,683

(22) PCT Filed: Mar. 12, 2002
(86) PCT No.: PCT/GB02/01134

(30) Foreign Application Priority Data
Mar. 13, 2001 (GB) 0106174.6

(51) Int. Cl. G06F 17/00; G06F 19/00

(52) U.S. Cl. 463/22; 463/42

(57) ABSTRACT

A gambling apparatus comprising: means for generating a random outcome; direct bet placing means for receiving a bet on the outcome; communication means for transmitting the outcome or data dictating the outcome; and at least one direct display means for generating a display of the outcome.

The present invention relates to a gambling apparatus

It is known in the art to provide coin-operated gambling machines (known colloquially as “fruit machines” and “one armed bandits”) in gaming institutions such as casinos and amusement arcades. Such machines typically comprise a housing containing three or more wheels. The outer surface of each wheel carries a series of symbols and is visible to the user of the machine through a window in the housing. When stationary, each wheel is in a position such that one symbol on the wheel is predominantly visible through the window. Thus the wheels jointly present a set of three or more symbols.

In use, a user inserts a coin into the machine and the wheels are set spinning either in response to the user pressing a button or pulling a lever on the side of the machine. The wheels spin independently of one another and are brought to a halt at a random moment so that each wheel displays a particular symbol to the user. Depending upon the particular rules governing the machine, a monetary prize is dispensed to the user if the particular set of three symbols appearing on the wheels corresponds to a predetermined winning set. In some machines, after the initial spin of the wheels, a user has the opportunity to re-spin certain of the wheels in order to change the set of symbols and increase the likelihood of winning a prize.

The problem with such prior art coin-operated gambling machines is that it is essential that the user of the machine directly operates the machine and must therefore have travelled to wherever the machine is located.

It is known to provide so-called “online gambling” arrangements in which individuals may access a central computer remotely, such as via the Internet. The central computer runs a “virtual game”, simulating the games that regularly exist in a casino, and on which individuals may place bets electronically in a manner corresponding to that in a real game. In such an online gambling arrangement, the central computer generates one or more “random” variables on which the result of the game is based. The problem with this type of online gambling arrangement is twofold. Firstly, it is not possible for a computer to generate a truly random variable and therefore there is a risk that individuals may eventually be able to calculate accurately or model the variable that the computer will generate, before placing their bet. Such individuals would then be able to cheat when placing bets. Secondly, and more importantly, because the individual is presented with a computer generated result which may have been produced in any way, individuals may be suspicious that the gambling arrangement is not being conducted fairly and that they do not have a reasonable chance of their bet winning. Therefore, individuals may be reluctant to use such online gambling arrangements.

It has been proposed that such online gambling arrangements be conducted around a live gambling event, which is transmitted to the individual, remotely, using a video camera and display. For example, U.S. Pat. No. 5,800,268 discloses a gambling arrangement in which an individual is able to place bets on a live event whilst watching the event from a remote position via a telephone line connection. Thus, the individual is able to view the proceedings surrounding the live gambling event and is therefore re-assured of the fairness of the gambling arrangement. The problem with this proposal is that sending video pictures remotely requires a large bandwidth of communication. The bandwidth required is not presently available to most users of the Internet. For example, to send a normal picture requires a baud rate of 256 kb. However, a typical domestic Internet connection has a maximum baud rate of 56 kb and, in practice, usually achieves a baud rate of only 28 kb.

The present invention seeks to alleviate one or more of the above problems.

According to, the present invention there is provided a gambling apparatus comprising: means for generating a random outcome; direct bet placing means for receiving a bet on the outcome; communication means for transmitting the outcome or data dictating the outcome; and at least one direct display means for generating a display of the outcome.

Preferably, the gambling apparatus further comprises at least one remote display means, in communication with the communication means, for generating a display of the outcome.

Conveniently, the means for generating a random outcome is in a first location and the at least one remote display means is in a second location, the communication means linking the first and second locations.

Advantageously, the gambling apparatus further comprises remote bet placing means for receiving a bet and transmitting information relating to the bet to the communication means.

Preferably, the gambling apparatus further comprises a database for receiving random outcomes and information relating to remotely placed bets, determining whether a bet on an outcome is a winning bet and storing the result.

Conveniently, the communication means transmits the outcome or data dictating the outcome and receives information relating to remotely placed bets via the Internet.

Advantageously, the means for generating a random outcome operates automatically, repeatedly generating random outcomes.

Preferably, the at least one direct display means comprises at least one spinnable wheel.

Conveniently, the means for generating a random outcome also comprises the at least one spinnable wheel, and a sensor for detecting the position of the wheel and generating the random outcome in response to the wheel position.

In order that the invention may be more readily understood and so that further features thereof may be appreciated, embodiments thereof will now be described, by way of example, with reference to the accompanying drawing in which:

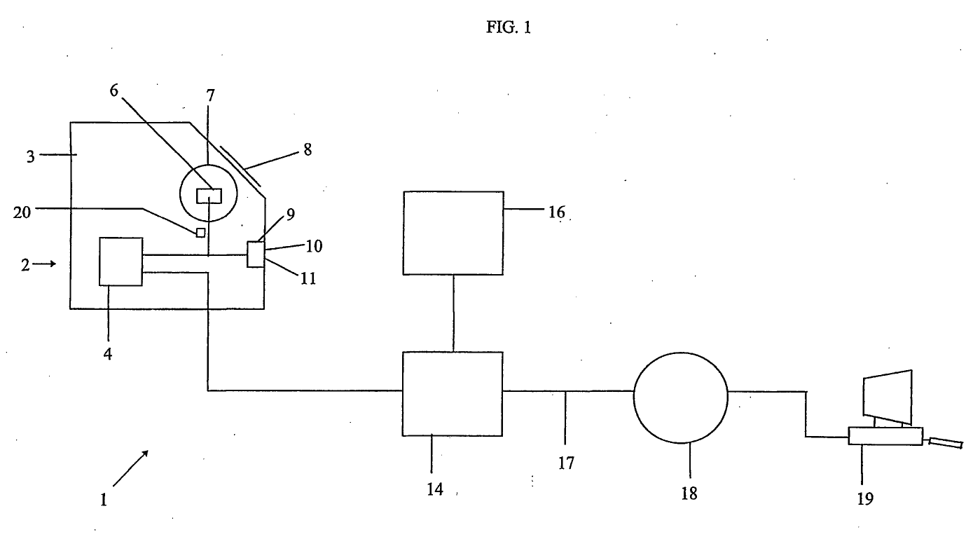

FIG. 1 is a schematic view of an embodiment of the invention.

Referring to FIG. 1 the gambling apparatus 1 comprises a coin-operated gambling machine 2 having a housing 3 containing a microprocessor 4. The microprocessor 4 is capable of generating a series of pseudo-random numbers. In certain other embodiments of the invention, the microprocessor 4 may be replaced by or supplemented with other means for generating random numbers such as an electromechanical device. The coin-operated gambling machine 2 is in a first location which is preferably a regulated area such as a licensed casino.

An output from the microprocessor 4 is connected to a motor 6. The motor 6 is connected independently to the axles of, in this example, three wheels 7 which are located coaxially adjacent a window 8 in the housing 3. The outer surface of each wheel 7 is provided with a series of symbols which are visible through the window 8. In response to a random number transmitted from the microprocessor 4, the motor 6 spins the three wheels 7 and then stops each wheel in a position dictated by the pseudo-random number. The wheels 7 move independently of one another and thus the final position of each wheel is substantially random. Furthermore, the exact position at which each wheel may be stopped is limited such that one particular symbol on each wheel is predominantly visible through the window 8 when the wheel is stopped. Thus the symbol that is predominantly visible when one of the wheels 7 is stopped accurately describes the position of the wheel. The three symbols that are predominantly visible on the stationary wheels represent a set of symbols.

Accordingly, the three wheels 7 effectively act as a direct display device for displaying a set of symbols dictated by to the random number generated by the microprocessor 4 and communicated directly to the wheels 7.

The microprocessor 4 is also connected to a coin collecting and dispensing unit 9, which is located adjacent the housing 3. The unit 9 has a slot 10 for receiving coins, tokens or any other form of monetary input, inserted by a direct user of the machine 2, which is connected to a coin storage receptacle, which, in turn, leads to a coin dispenser 11. A mechanism is provided between the coin storage receptacle and the coin dispenser 11 such that coins are only dispensed in response to winning sets of symbols.

In some other embodiments, the coin collecting and dispensing unit 9 is replaced with a credit or debit card reading unit. In these embodiments, payment is effected from the direct user's credit or debit card account and, similarly, prizes are credited to the direct user's account. The credit or debit card is, in some embodiments, issued by the operators of the first location.

The output of the microprocessor 4 is also connected to a server 14 located externally of the housing 3. The server 14 is connected to a database 16. The database 16 receives the random number data from the server 14. The database 16 contains entries relating to the identity of a remote user and the running total of an account of the remote user in relation to the gambling apparatus.

It is to be appreciated that, since the position of the wheels 7 is dictated by the random number generated by the microprocessor 4, which is sent to the motor 6, any random number produced by the microprocessor 4 is effectively a description of a particular set of positions of the three wheels 7. Thus, transmitting the random number, alone, is sufficient to communicate the position of the three wheels 7.

The server 14 also encrypts the random number data and sends it via a communication line 17 via the Internet 18 to a personal computer 19 of a remote user. The personal computer 19 is in a second location, different from the first location, such as the remote user's home. The personal computer 19 is programmed to decrypt the random number data and to present to the remote user a graphical representation of the wheels 7. In particular, the graphical representation shows the wheels 7 in the position in which they appear to a direct user of the coin-operated gambling machine 2, through the window 8. Thus, when the wheels are spinning, the graphical representation is of the wheels 7 spinning and, when the wheels 7 are stationary, the graphical representation displayed tallies with the set of symbols that are predominantly visible to a direct user of the coin-operated gambling machine 2.

Accordingly, the personal computer 19 acts as a remote display device for displaying a set of symbols corresponding to the random number generated by the microprocessor 4 and communicated indirectly to the personal computer 19, via the server 14.

The personal computer 19 is also programmed to receive bets from the remote user and transmit these via the Internet 18 to the server 14. The server 14, in turn, transmitting the betting information to the database 16.

The microprocessor 4 automatically generates pseudo-random numbers and initiatates spinning of the wheels on a regular basis. Thus, the microprocessor 4 operates automatically, repeatedly generating random numbers and spinning the wheels to display sets of symbols. In order to place a bet on a given outcome of the symbols, a direct user and a remote user are given a short period, for example ten seconds, in which to choose whether or not to place a bet, after which time bets are closed and the wheels begin to spin.

To place a bet, a direct user places a coin in the coin slot 10 and the coin collecting and dispensing unit 9 is thus notified that a bet has been placed by the direct user. In the embodiments in which a credit or debit card reader replaces the coin collecting and dispensing unit 9, the direct user inserts a credit or debit card into the reader to effect payment. In order for a remote user to place a bet, the remote user instructs the personal computer 19 that a particular bet is to be placed and this information is transmitted, via the Internet 18 to the server 14. The server 14, in turn, transmits the information to the database 16. The database 16 records the bet placed against the identity of the remote user and deducts the bet placed from the account details maintained by the database 16 for that user.

The microprocessor 4 then generates a pseudo-random number which is transmitted to the motor 6 and the coin collecting and dispensing unit 9. In response to the pseudo-random number, the motor 6 begins spinning the three wheels 7 and, after a few seconds of spinning, independently stops each wheel such that a particular symbol is predominantly visible to the direct user on each wheel 7 through the window 8. If the set of three symbols that are predominantly visible corresponds to a predetermined winning set then the unit 9 is pre-programmed to activate the mechanism between the coin storage receptacle in the unit 9 and the coin dispenser 11 and thus to dispense a monetary prize through the dispenser 11, for retrieval by the direct user. In the embodiments in which a credit or debit card reader replaces the coin collecting and dispensing unit 9, the prize is credited to the direct user's account.

At the same time as the random number is transmitted to the motor 6 and to the coin collecting and dispensing unit 9, it is also transmitted to the server 14. The server 14 transmits the random number to the database 16 where the remote user's entry in the database is updated. If the set of three symbols are a winning set, the database 16 adds to the remote user's account the winnings appropriate to the remote user's original bet. In some embodiments, the database 16 can connect to the remote user's debit or credit card account, automatically debiting and crediting amounts to the account as the remote user places and wins bets, respectively. Both the direct user and the remote user can accumulate prizes to use as payment for subsequent bets.

At the same time as the server 14 transmits the random data to the database 16, it also encrypts the random number and transmits it, via the Internet 18 to the personal computer 19. The personal computer 19 then decrypts the random number information and changes the graphical representation from one of spinning wheels to a display which corresponds to the view of the wheels 7 which is visible to the direct user through the window 8. In particular, the set of three symbols that are predominantly visible to the direct user is shown in the graphical representation. The personal computer 19 is also programmed to advise the remote user if the set of three symbols is a winning set and of the prize that has been won.

It is to be appreciated that the only information that needs to be transmitted to the personal computer 19 in order for it to generate the graphical representation is the encrypted random number. The encrypted random number is relatively small, and is thus transmitted relatively quickly by the communication line 17 and Internet 18 using an absolute minimum of bandwidth. Consequently, the graphical representation on the personal computer 19 is generated substantially simultaneously with the wheels 7 stopping in the housing 3. The graphical representation of the wheels is generated by the remote user's personal computer 19 thereby saving on bandwidth requirements. This allows the pace of the game to be maintained, in order to keep the direct and remote user's interest and also reduces the possibility of collusion between the direct user and the remote user, which might lead to cheating. Furthermore, since the remote user is aware that his position is equivalent to that of the direct user, he is reassured that his chances of success are the same as if he were physically present at the coin-operated gambling machine 2.

While this embodiment of the invention has been described with only a single remote user, it is to be understood that, in other embodiments, multiple remote users could participate, each being provided with a separate personal computer 19 and connection to the server 14.

It is to be appreciated that in other embodiments of the invention, a different number of wheels 7 may be provided in the coin operated slot machine 2, instead of the three wheels described above. In particular, it is envisaged that one, five or even nine wheels may be provided.

Connection between the slot machine, the server and the remote computer 19 need not necessarily be hardwired but can be a wireless connection. Wireless connection is especially well-suited to embodiments of this invention owing to the low bandwidth requirements. Indeed, the personal computer 19 could readily be a mobile communication device such as an Internet enabled telephone.

In the above embodiments of the invention, information regarding the halted position of the wheels 7 after spinning and thus the identity of the set of symbols predominantly visible on the halted wheels through the housing 8 is transmitted via the server 14 to the personal computer 19 by transmitting the pseudo-random number that was generated by the microprocessor 4 when commencing the spin. However, in other embodiments, the pseudo-random number is not transmitted to the personal computer 19. Instead a sensor 20 is provided adjacent the wheels 7 in the housing 3. The sensor 20 determines the position of each wheel and transmits the position data to the server 14 which, in turn, transmits it to the database 16 and personal computer 19. The personal computer 19 uses the position data to generate an appropriate graphical representation of the wheels 7 and to determine whether or not the set of three symbols is a winning set. Similarly, the database 16 uses the position data to update the remote user's entry in the database and to update the remote user's account if the set of three symbols is a winning set.

In some of these embodiments, the pseudo-random number generated by the microprocessor does not completely dictate the halted position of the wheels 7 after they have spun. Instead, the pseudo-random number results in the spinning and halting of the wheels 7 within certain parameters but the inherent unpredictability of the spinning wheels themselves introduces a further level of randomness to the outcome of the set of three symbols predominantly visible on the halted wheels 7. Thus, in these embodiments, the pseudo-random number, alone, is not a description of the halted positions of the three wheels 7.

In other embodiments of the invention, the mechanical apparatus of the motor 6 and the three wheels 7 is replaced by, or supplemented with, a computer generated animated video showing the set of symbols dictated by the random number generated by the microprocessor.

In some other embodiments, the game played by the coin-operated gambling machine 2 is different from that described above. In particular, card games such as poker are played instead in some embodiments. In these embodiments, the motor 6 and the three wheels 7 are replaced by a display means suitable for the game such as the computer generated animated videos described above.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1-11 (canceled)

12: A gambling apparatus comprising: means for generating a random or pseudo-random outcome; remote bet placing means for receiving a bet, over a communication line from a remote location, on the outcome; direct bet placing means for receiving a bet from a direct user; communication means for transmitting data dictating the outcome to the remote location; at least one remote display means for generating a display of the outcome at the remote location; and at least one direct display means for generating a display of the outcome at the gambling apparatus.

13: A gambling apparatus according to claim 12 further comprising a database for receiving random or pseudo-random outcomes and information relating to remotely placed bets, determining whether a bet on an outcome is a winning bet and storing the result.

14: A gambling apparatus according to claim 12, wherein the communication means transmits data dictating the outcome and receives information relating to remotely placed bets via the Internet.

15: A gambling apparatus according to claim 13, wherein the communication means transmits data dictating the outcome and receives information relating to remotely placed bets via the Internet.

16: A gambling apparatus according to claim 12, wherein the means for generating a random or pseudo-random outcome operates automatically, repeatedly generating random or pseudo-random outcomes.

17: A gambling apparatus according to claim 13, wherein the means for generating a random or pseudo-random outcome operates automatically, repeatedly generating random or pseudo-random outcomes.

18: A gambling apparatus according to claim 14, wherein the means for generating a random or pseudo-random outcome operates automatically, repeatedly generating random or pseudo-random outcomes.

19: A gambling apparatus according to claim 15, wherein the means for generating a random or pseudo-random outcome operates automatically, repeatedly generating random or pseudo-random outcomes.

20: A gambling apparatus according to claim 12, wherein the at least one direct display means comprises at least one spinnable wheel.

21: A gambling apparatus according to claim 13, wherein the at least one direct display means comprises at least one spinnable wheel.

22: A gambling apparatus according to claim 14, wherein the at least one direct display means comprises at least one spinnable wheel.

23: A gambling apparatus according to claim 15, wherein the at least one direct display means comprises at least one spinnable wheel.

24: A gambling apparatus according to claim 16, wherein the at least one direct display means comprises at least one spinnable wheel.

25: A gambling apparatus according to claim 17, wherein the at least one direct display means comprises at least one spinnable wheel.

26: A gambling apparatus according to claim 18, wherein the at least one direct display means comprises at least one spinnable wheel.

27: A gambling apparatus according to claim 19, wherein the at least one direct display means comprises at least one spinnable wheel.
